(19) United States
(12) Patent Application Publication
(10) Pub. No.: US 2025/0155407 A1
(43) Pub. Date: May 15, 2025

(54) AEROSOL MICROSENSOR

(71) Applicant: The Johns Hopkins University, Baltimore, MD (US)

(72) Inventors: Rebecca G. Lilly, Laurel, MD (US); Felix C. Sage, Ijamsville, MD (US); Jeffrey F. Garstecki, Sugar Mountain, NC (US); Leah S. Talbott, Columbia, MD (US); Jason M. Klimek, Owings Mills, MD (US); Sherry Chiu, Silver Spring, MD (US); Corrine E. Fuller, Columbia, MD (US); Brian E. Damit, Silver Spring, MD (US); Charles C. Young, Mount Airy, MD (US); Christopher J. Rosenker, Woodbine, MD (US); Matthew D. Cross, Laurel, MD (US)

(73) Assignee: The Johns Hopkins University, Baltimore, MD (US)

(21) Appl. No.: 18/817,374

(22) Filed: Aug. 28, 2024

Related U.S. Application Data
(60) Provisional application No. 63/598,209, filed on Nov. 13, 2023.

(51) Int. Cl. G01N 29/02; G01N 29/036

(52) U.S. Cl. CPC G01N 29/022; G01N 29/036; G01N 2291/0255; G01N 2291/0256

(57) ABSTRACT

A sensor includes a microcontroller coupled to a sensing oscillator, a reference oscillator, an environmental sensor, and a communication medium. The sensing oscillator may be less than two inches long and contain a component that changes in oscillation frequency in response to an aerosol particle, liquid-borne analyte, and/or chemical vapor attaching, depositing, and/or interacting with an outer surface of the component. The reference oscillator and environmental sensor may be used to calibrate the sensing oscillator. Data from the sensing oscillator, the reference oscillator and/or the environmental sensor is transferred to an external source by the communication medium.

### CROSS REFERENCE TO RELATED APPLICATIONS

This application claims benefit of U.S. Provisional Patent Application 63/598,209 filed on Nov. 13, 2023, which is incorporated by reference herein in its entirety.

### STATEMENT REGARDING FEDERALLY SPONSORED RESEARCH OR DEVELOPMENT

This invention was made with Government support under Contract No. N00024-13-D-6400 awarded by the United States Department of the Navy. The Government has certain rights in the invention.

### BACKGROUND

### Field

The embodiments disclosed herein relate to systems and methods for detecting aerosol particles, liquid-borne analytes, and/or chemical vapors using a microscale sensor.

### Background

Quartz crystal microbalance sensors are commonly used to detect chemical and biological material. These sensors typically contain a quartz crystal that oscillates at a resonance frequency in response to an applied voltage. When material in the environment interacts with the surface of the crystal, the oscillation frequency of the crystal changes, thereby indicating that chemical and/or biological material is present.

Current versions of quartz crystal microbalance sensors are large and contain, for example, footprints greater than one foot by one foot. This makes it difficult to integrate quartz crystal microbalance sensors for critical applications, for example, wearable and/or mobile platform-based sensors. Large quartz crystal microbalance sensors may experience reduced sensitivity due to the large number of particles that must bind to the crystals' surface in order to cause a detectable shift in oscillation frequency.

### SUMMARY

Accordingly, it is desirable to design a quartz crystal microbalance sensor with a small footprint and enhanced sensitivity.

In some aspects, a sensor comprises a microcontroller coupled to a sensing oscillator, a reference oscillator, an environmental sensor, and a communication medium. The sensing oscillator may have a length less than about two inches long and may contain a component configured to change in oscillation frequency in response to an aerosol particle, liquid-borne analyte, and/or chemical vapor attaching, depositing, and/or interacting with an outer surface of the component. The reference oscillator may act as a timing reference for the sensing oscillator. Data from the environmental sensor may be used to calibrate the sensing oscillator. The communication medium may transfer data from the sensing oscillator, the reference oscillator, and/or the environmental sensor to an external source.

In some aspects, a method comprises evaluating a frequency of a sensing oscillator having a length of less than about two inches. The evaluating comprises using counters to compare time varying frequencies of the sensing oscillator to a control oscillator, and analyzing frequency data to determine any aerosol particles, liquid-borne analyte, and/or chemical vapors present in an environment.

### BRIEF DESCRIPTION OF THE DRAWINGS/FIGURES

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIGS. 1A and 1B show schematics of a sensing oscillator, according to some aspects.

FIGS. 2A and 2B show a top view of a sensor, according to some aspects.

FIG. 3 shows a block diagram of a sensor, according to some aspects.

FIG. 4 shows a flowchart of a method of detecting particles in an environment, according to some aspects.

FIG. 5 shows a computer system, according to some aspects.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The aspects described herein, and references in the specification to “one aspect,” “an aspect,” “an exemplary aspect,” “an example aspect,” etc., indicate that the aspects described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of those skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The terms “about,” “approximately,” or the like can be used herein indicates the value of a given quantity that can vary based on a particular technology. Based on the particular technology, the terms “about,” “approximately,” or the like can indicate a value of a given quantity that varies within, for example, 10-30% of the value (e.g., +10%, +20%, or +30% of the value).

Aspects of the present disclosure can be implemented in hardware, firmware, software, or any combination thereof. Aspects of the disclosure can also be implemented as instructions stored on a computer-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Furthermore, firmware, software, routines, and/or instructions can be described herein as performing certain actions. However, it should be appreciated that such descriptions are merely for convenience and that such actions result from computing devices, processors, controllers, or other devices executing the firmware, software, routines, instructions, etc. The term “machine-readable medium” can be interchangeable with similar terms, for example, “computer program product,” “computer-readable medium,” “non-transitory computer-readable medium,” or the like. The term “non-transitory” can be used herein to characterize one or more forms of computer readable media except for a transitory, propagating signal.

As described herein, the term “particle” may refer to an aerosol particle, a liquid borne analyte, a chemical vapor, gas, or the like.

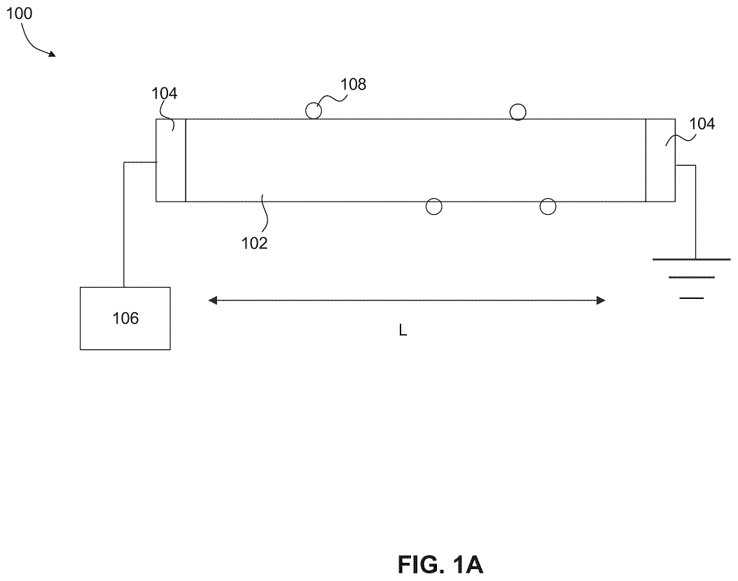

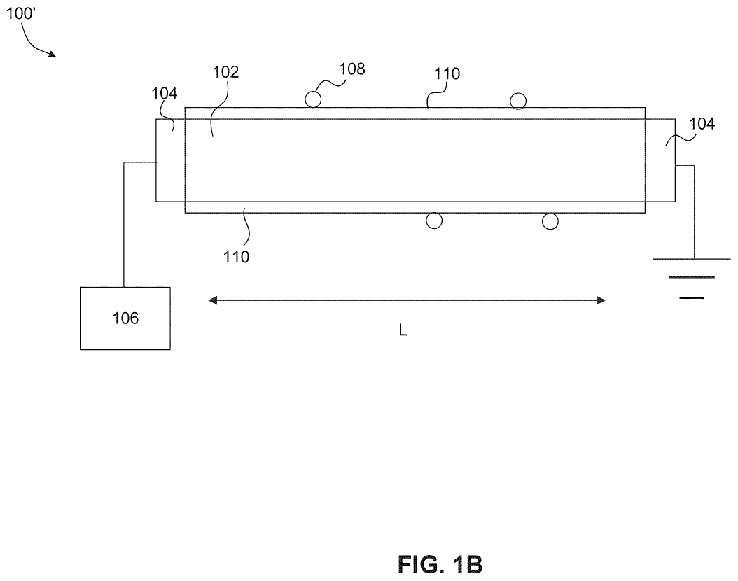

FIGS. 1A and 1B show example sensing oscillators 100 and 100′, according to some aspects. Sensing oscillators 100 and 100′ may comprise a crystal 102, electrical contacts 104, and a voltage supply 106. Crystal 102 may comprise a piezo-electric material, such as quartz or the like.

In some aspects, voltage supply 106 may supply a voltage drop across electrical contacts 104, thus inducing an alternating current in crystal 102. If the alternating current is close to a natural frequency of crystal 102, crystal 102 may deform at a frequency in resonance with the alternating current.

In some aspects, a particle 108 may attach, deposit onto, or interact with an outer surface of crystal 102. This may alter the oscillation frequency of the crystal, thus allowing the presence of particle 108 to be detected.

In some aspects, sensing oscillator 100′, as shown in FIG. 1B, may additionally include a coating 110 disposed on the surface of crystal 102. The coating may increase the selectivity of the sensing oscillator 100′. For example, coating 110 may comprise an antibody or chemical group that is configured to bind to specific particles or classes of particles. Because only these particles will bind to coating 110, if a frequency shift is observed, the specified class of particles may be present.

In some aspects, the size of crystal 102 may determine its sensitivity. For example, due to its smaller mass, a smaller sensing crystal may exhibit different sensing physics and a more pronounced frequency shift when a particle attaches, deposits, and/or interacts with its surface. This may allow a shift in oscillation frequency to be detected when fewer particles interact with the surface of the crystal, thus providing greater sensitivity. To achieve a desired sensitivity, crystal 102 may have a length L that is less than about 2 inches.

It may be understood by a person of ordinary skill in the art that crystal 102 may be substituted for other oscillating components.

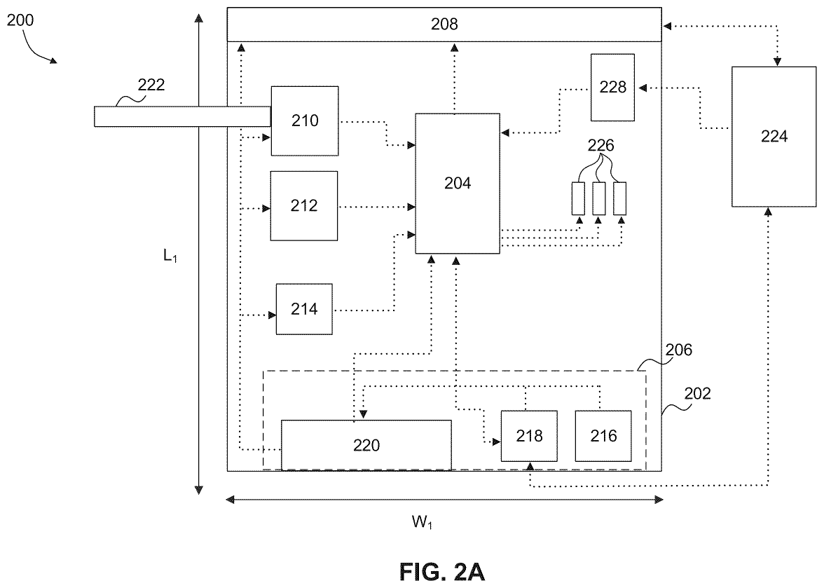

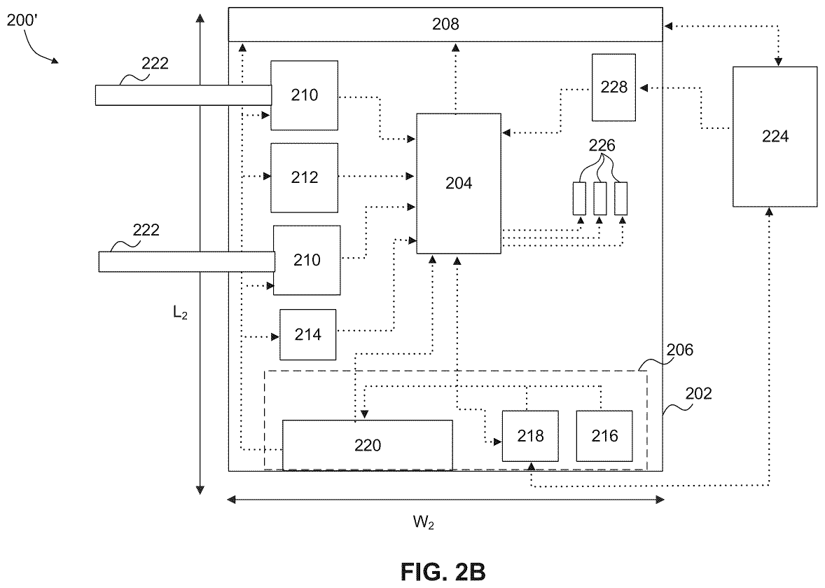

FIG. 2A shows a schematic of a top view of a sensor 200, according to some aspects. Sensor 200 may include a circuit board 202, which may contain a microcontroller 204, power circuitry 206, and a Bluetooth module 208. External sensors, such as a sensing oscillator 210, a reference oscillator 212, and an environmental sensor 214 may be coupled to microcontroller 204.

In some aspects, power circuitry 206 comprises a power connector 216. Power connector 216 may comprise power clips through which an eternal power source, such as a DC power supply or a battery, are connected to circuit board 202. Power circuitry 206 may also contain a serial communication connector 218, which may supply voltage to circuit board 202 and/or transmit data from microcontroller 204 to an external source. In some aspects, voltage entering circuit board 202 can be routed towards a power switch 220. Power switch 220 may turn sensor 200 on or off. Additionally, when more than one power source is available, power switch 220 may determine which power source is connected to sensor 200.

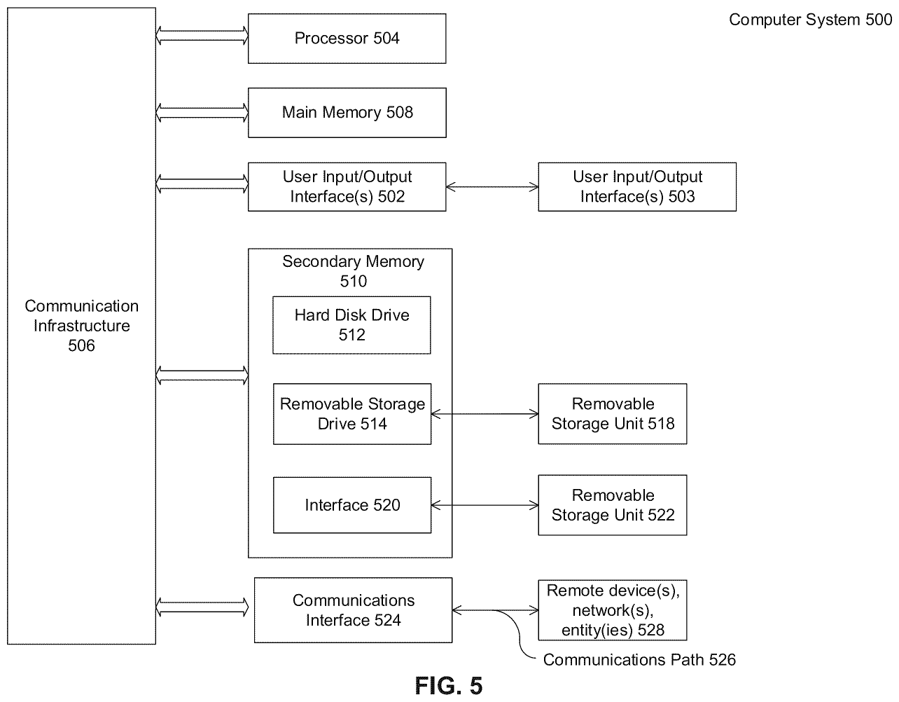

In some aspects, microcontroller 204 may comprise a compact integrated circuit designed to govern specific operations of sensor 200. For example, microcontroller 204, which may contain a processor, memory and input/output ports, may receive and process data from sensing oscillator 210, reference oscillator 212, and environmental sensor 214. In some aspects, microcontroller 204 is a simplified version of computer system 500, shown in FIG. 5.

In some aspects, sensing oscillator 210 may be configured to detect particles in an environment through changes in oscillation frequency in response to a particle attaching, depositing, and/or interacting with its outer surface. For example, sensing oscillator 210 may comprise a crystal oscillator, such as a temperature compensated crystal oscillator (TCXO), or the like. Alternatively, non-temperature compensated crystal oscillators may also be used. The crystal oscillator may be open to a surrounding environment such that particles are able to bind to or interact with the crystal's surface.

In some aspects, sensor 200 may include a component 222 for delivery of particles to the surface of the sensing oscillator 210. Component 222 may comprise a channel or the like. In some aspects, the crystal of the sensing oscillator 210 is uncoated, allowing a variety of particles to attach, deposit, and/or interact with its surface. In other aspects, the crystal of the sensing oscillator 210 is coated and thus only specific particles or classes of particles may bind to or interact with its surface.

In some aspects, the size of the crystal of sensing oscillator 210 may determine its sensitivity. For example, a smaller crystal may have a pronounced frequency shift when a particle attaches, deposits, and/or interacts with its surface. This may allow a shift in oscillation frequency to be detected when fewer particles interact with the surface of the crystal, thus providing greater sensitivity. To achieve a desired sensitivity, sensing oscillator 210 may have a length approximately 2 inches to almost 0 inches, for example less than about 2 inches long, a length less than about 1 centimeter long, or a length less than about 5 millimeters long.

In some aspects, sensing oscillator 210 may be connected to microcontroller 204 via an input/output port.

The oscillation frequency of the crystal of the sensing oscillator 210 may be influenced by several environmental factors, such as temperature, pressure and humidity. This may make it difficult to determine if changes in oscillation frequency are due to particles attaching, depositing, and/or interacting with the surface of sensing oscillator 210, or are due to changes in environmental conditions.

In some aspects, changes in environmental conditions can be accounted for by including a reference oscillator 212 in sensor 200. Reference oscillator 212 may be subject to the same environmental conditions as sensing oscillator 210, thus, utilizing reference oscillator 212 as a timing reference may cancel out environmental factors.

In some aspects, reference oscillator 212 may comprise the same size and type of crystal as sensing oscillator 210. The crystal in reference oscillator 212 may be covered such that particles do not attach, deposit, and/or interact to its surface. In some aspects, reference oscillator 212 may be coupled to microcontroller 204 via an input/output port.

In some aspects, environmental factors may be further accounted for by including an environmental sensor 214 in sensor 200. Environmental sensor 214 may provide additional calibration data for the sensing oscillator 210, such as temperature, humidity, pressure and/or acceleration data. Although not shown in FIG. 2A, sensor 200 can contain more than one environmental sensor 214. Similar to sensing oscillator 210 and reference oscillator 212, environmental sensor 214 may be coupled to microcontroller 204 via an input/output port.

In some aspects, microcontroller 204 may receive data from sensing oscillator 210, reference oscillator 212, and environmental sensor 214. Microcontroller 204 may be configured to process data received from these sensors. For example, microcontroller 204 may use a series of counters to determine an oscillation frequency of sensing oscillator 210. Furthermore, microcontroller 204 may analyze changes in the oscillation frequency to determine if particles are present in an environment surrounding sensing oscillator 210.

In some aspects, data received and/or processed by microcontroller 204 may be transmitted to an external system 224. External system 224 can comprise a computer system or the like. Data can be wirelessly transmitted from microcontroller 204 to external system 224 through Bluetooth system 208. In an alternative aspect, data may be physically transmitted from sensor 200 to external system 224 via a physical connection (e.g., cable) coupled to serial communication connector 218.

In some aspects, sensor 200 may contain one or more light emitting diodes (LED) 226. One or more LED's 226 may be connected to microcontroller 204 via an input/output port. Microcontroller 204 may send a voltage to at least one of the one or more LED's 226 when a certain state of sensor 200 is reached, causing the LED to emit light. For example, microcontroller 204 may send a voltage to one or more LED's 226 when a particle or material has been detected.

In some aspects, sensor 200 contains a data port 228. Data port 228 may be used to debug or install firmware updates to microcontroller 204 via a connection with external system 224.

In some aspects, sensor 200 has a length L₁ and a width W₁. Length L₁ and width W₁ may be less than about 6 inches, less than about 2 inches or less than about 1.5 inches.

FIG. 2B shows a sensor 200′, according to some aspects. Sensor 200′ may be an alternative embodiment of sensor 200 described in FIG. 2A. Commonly numbered elements between FIGS. 2A and 2B may be assumed to have approximately the same purpose and function.

Sensor 200′ may contain more than one sensing oscillator 210. In one aspect, sensor 200′ contains a sensing oscillator 210 comprising, e.g., an uncoated crystal, and one or more sensing oscillators 210 comprising, e.g., one or more coated crystals. In some aspects, each of the one or more coated crystals of the sensing oscillators 210 may include a different coating configured to bind to a different particle or class of particles, as described in reference to FIG. 1B. In another aspect, sensor 200′ may contain at least two sensing oscillators 210, each of which contains a crystal. Each of the crystals of the sensing oscillators 210 may include a different coating, such that each crystal of the sensing oscillators 210 is configured to detect a different particle or class of particles.

Sensor 200′ may contain a single reference oscillator 212, which acts as a timing reference for multiple sensing oscillators 210. In some aspects, sensor 200′ may contain multiple reference oscillators 212.

The number of sensing oscillators 210 incorporated into sensor 200′ may affect the dimensions of sensor 200′. In some aspects, sensor 200′ may have a length L₂ and a width W₂. Length L₂ and width W₂ may be less than about 8 inches, less than about 6 inches, less than about 4 inches or less than about 1.5 inches.

In some aspects, sensor 200 or 200′ may be configured as a wearable sensor. In additional aspects, sensor 200 or 200′ may be integrated into a mobile system. For example, sensor 200 can be integrated into a vehicle, an unmanned aircraft, or the like. Sensor 200 or 200′ may receive power form power sources onboard the mobile system.

In further aspects, sensor 200 may be integrated into a stationary system. For example, sensor 200 may be connected to a power source in a building.

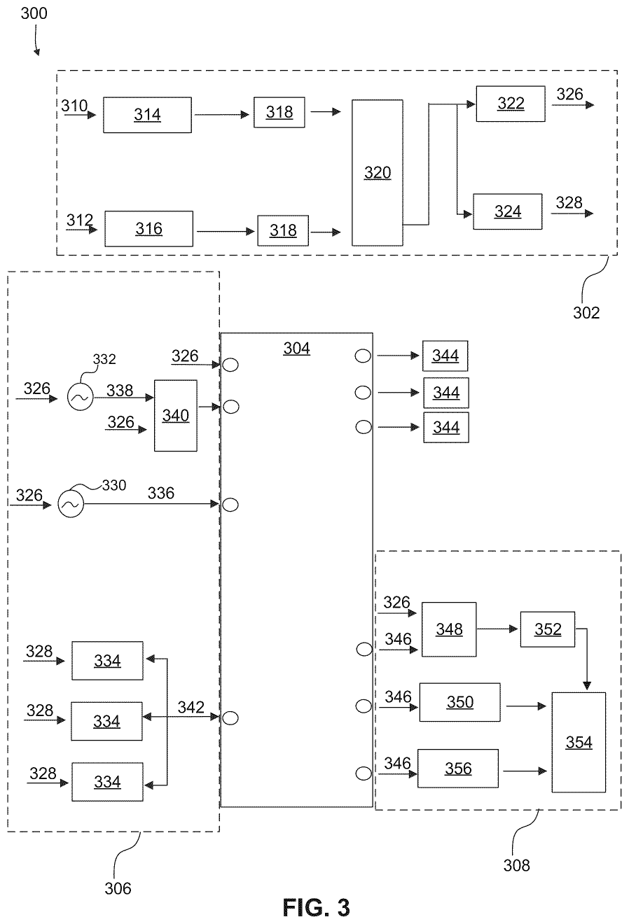

FIG. 3 illustrates a block diagram 300, according to some aspects. Block diagram 300 may show a general arrangement of components of a sensor, such as sensors 200 and 200′ described in FIGS. 2A and 2B.

In one example, block diagram 300 may contain a power system 302, a microcontroller 304, an external sensor block 306, and a communications infrastructure block 308. While block diagram 300 is described herein in reference to a circuit board containing a microcontroller and external sensors, block diagram 300 is not limited to this embodiment.

In some aspects, power system 302 shows power components and circuitry used to deliver power to microcontroller 304, external sensors 306, and communication infrastructure 308. Power system 302 may obtain voltage inputs from a direct current (DC) power supply 310 and/or a battery 312. A connector 314 may receive voltage from DC power supply 310, while a connector 316 may receive power from battery 312. In some aspects, connectors 314 and 316 may transfer the supplied voltage(s) from the power supply and/or battery to a reverse voltage protection circuit 318 located on the circuit board. The supplied voltage may then enter power switch 320, which may determine which of power supply 310 or battery 312 supplies power to the sensor.

In some aspects, the voltage exiting the power switch 320 may enter linear voltage regulators 322 and 324. Regulators 322 and 324 may ensure constant output voltages 326 and 328, respectively. Voltage 326 and voltage 328 can supply power to various components of the sensor.

In some aspects, external sensor block 306 can include a sensing oscillator 330, a reference oscillator 332, and one or more environmental sensors 334. Each of sensing oscillator 330, reference oscillator 332, and one or more environmental sensors 334 can input data to microcontroller 304 and may have a similar form and function to similarly named components described in reference to FIGS. 2A and 2B.

In some aspects, sensing oscillator 330 receives power from voltage 326. As described in reference to FIGS. 1A and 1B, the applied voltage may cause sensing oscillator 330 to oscillate at a resonance frequency. Data 336 from sensing oscillator 330 may be input to microcontroller 304 via an input/output pin. A first counter in microcontroller 304 may record the frequency of data 336.

In some aspects, reference oscillator 332 may receive power from voltage 326. Similar to sensing oscillator 330, the applied voltage may cause reference oscillator 332 oscillate at a resonance frequency. Data 338 from reference oscillator 332 may be sent to microcontroller 304, where the frequency is measured by a second counter.

In some aspects, when reference oscillator 332 is the same type of oscillator and approximately the same size as sensing oscillator 330, reference oscillator 332 may act as a timing reference for sensing oscillator 330.

For example, in one aspect sensing oscillator 330 may be configured as a clock input to microcontroller 304. A first counter in the microcontroller may be incremented by one each time data 336 has completed a full period. Because only one input may be configured as a clock in microcontroller 304, data 338 from reference oscillator 332 may be input to a general purpose input/output (GPIO) pin of microcontroller 304.

In one example, when the voltage of the GPIO pin is below a certain voltage threshold, it can be detected as logic zero. Similarly, if the voltage exceeds the same threshold, it may be detected as logic 1. Changes in the GPIO's pin state may only be accurately detected if the frequency of these changes is below a certain limit. Due to this restraint, data 338 from closed oscillator 332 may pass through a ripple counter 340, which divides the frequency before it passed to microcontroller 304.

In some aspects, the first counter and the second counter in microcontroller 304 can be configured to asynchronously signal events to each other to complete a frequency measurement process. The second counter may act as a reference for the measurement of data 336. For example, the second counter may be configured to, starting from a value of zero, count up to a maximum count value, which may be set such that it takes the second counter exactly one second to reach the maximum count value. The second counter may also send event signals to the first counter at the start of the count period (when the second counter has a period of zero) and when the maximum count value has been reached. The first counter may receive the event signals and store its current count value in a register. The second counter may also be configured to trigger and interrupt in microcontroller 304 once the maximum count value is reached.

In some aspects, during the interrupt routine, microcontroller 304 may read the register of the first counter and calculate the difference between a first value, recorded when the second counter has a value of zero, and a second value, recorded when the second counter reaches the maximum count value. This difference between the first and second values can be interpreted as the frequency of sensing oscillator 330.

The counting method described is only one example of a frequency counting method. Other frequency counting methods can be envisaged based on the knowledge of a person of ordinary skill in the art.

In addition to data received from sensing oscillator 330 and reference oscillator 332, microcontroller 304 may also receive data from one or more environmental sensors 334, which may be powered by voltage 328. One or more environmental sensors 334 may measure as non-limiting examples, temperature, humidity, acceleration, and/or pressure. Data 342, generated by one or more environmental sensors 334, may be set to microcontroller 304 via a communication medium, such as an inter-integrated circuit protocol (I2C), a serial peripheral interface (SPI), or the like.

In some aspects, one or more LED's 344 may be connected to microcontroller 304 via a general input/general output pin. The one or more LEDs 344 can show different states of the microcontroller. For example, an LED can receive a voltage from microcontroller 304 that causes it to light up if a particle is detected.

In some aspects, microcontroller 304 may send data 346 to communication block 308. Data 346 may contain raw frequency and environmental data measurements from sensing oscillator 330, reference oscillator 332, and/or one or more environmental sensors 334. In an alternative aspect, data 346 may contain data that has been processed by microcontroller 304. For example, data 346 may contain data that has been processed to account for environmental factors, or may contain detection data.

In some aspects, communication block 308 may include a Bluetooth module 348 and a serial communication connector 350. Bluetooth module 348 may receive data 346 through a communication interface, such as a serial peripheral interface (SPI), or the like. Bluetooth module 348 may also contain an antenna 352, which may be used to transmit data 346 to an external device 354. Serial communication connector 350 may include a cable or the like that provides a wired connection between microcontroller 304 and external device 354.

In some aspects, communication block 308 may also comprise a data port 356. Data port 356 may be connected to external system 354 via a cable or the like. Data port 356 may be used to debug and/or send firmware updates to microcontroller 304.

In some aspects, external device 354 may comprise a computer system (e.g., computer system 500 in FIG. 5) or the like. The computer system may contain program instructions that allow for particle detection and identification through analysis of data 346.

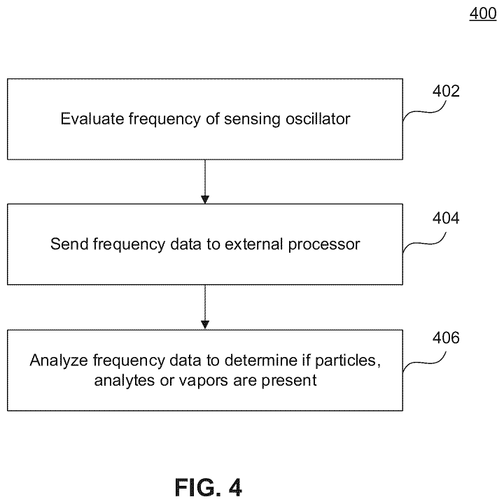

FIG. 4 illustrates a flowchart of a method 400, according to some aspects. In some implementations, method 400 may be used to detect aerosol particles, chemical vapors, liquid-borne analytes, or the like. It is to be appreciated that not all steps may be needed to perform the disclosure provided herein. Furthermore, some of the steps may be performed simultaneously, or in a different order than the one shown in FIG. 4 as will be understood by a person of ordinary skill in art.

In step 402, frequency data of a sensing oscillator may be collected and evaluated, according to some aspects. The sensing oscillator may comprise a quartz crystal that oscillates in resonance with an applied voltage. Particles in an environment may be detected by the crystal of the sensing oscillator by analyzing a change of oscillation frequency of the sensing oscillator when particles attach, deposit onto, or interact with its surface. The sensing oscillator may be connected to a microprocessor, which may utilize data from a reference oscillator and series of counters to determine its frequency, e.g., as described above in reference to FIG. 3.

In step 404, frequency measurements of the sensing oscillator may be sent to an external processor, according to some aspects. The frequency measurements may be sent via Bluetooth or via a wired connection.

In step 406, the frequency data may be analyzed to determine if aerosol particles, chemical vapors, liquid-borne analytes or the like are present in the environment surrounding the sensing oscillator, according to some aspects.

The frequency data may be analyzed locally by the microprocessor, or by the external processor described in step 404. Analysis of the frequency data may include reviewing shifts in oscillation frequency of the sensing oscillator, which may indicate that a particle is present. In some aspects, the shifts in oscillation frequency may be compared to a database of frequency shifts to determine the type of aerosol particle, chemical vapor, and/or liquid-borne analyte present in the environment. Analysis may also include adjusting the frequency data (using data collected by one or more environmental sensors) to account for environmental factors that affect oscillation frequency, such as temperature, pressure, humidity and acceleration.

In some aspects, the steps of method 400 may be implemented in parallel for at least two sensing oscillators.

FIG. 5 shows a computer system 500, according to some aspects. One or more computer systems 500 may be used, for example, to implement any of the aspects discussed in FIGS. 1A, 1B, 2A, 2B, 3, and/or 4, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of remote or external devices, networks, entities, etc. (individually and collectively referenced by reference number 528). For example, communication interface 524 may allow computer system 500 to communicate with remote or external devices, networks, or entities 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A sensor comprising:
a sensing oscillator comprising a component configured to change in oscillation frequency in response to an aerosol particle, liquid-borne analyte, and/or chemical vapor attaching, depositing, and/or interacting with an outer surface of the component, wherein the sensing oscillator is less than about two inches long;
a reference oscillator configured to act as a timing reference for the sensing oscillator;
an environmental sensor;
a communication medium configured to transfer data from the sensing oscillator, the reference oscillator, and/or the environmental sensor to an external source; and
a microcontroller coupled to the sensing oscillator, the reference oscillator, the environmental sensor, and/or the communication medium.

2. The sensor of claim 1, wherein the component comprises a crystal.

3. The sensor of claim 2, wherein the crystal is temperature compensated.

4. The sensor of claim 1, wherein:
the component comprises a coating, and
the coating is configured to selectively bind to a specific particle or class of particles and/or analytes.

5. The sensor of claim 4, wherein the coating comprises an antibody.

6. The sensor of claim 1, further comprising:
another sensing oscillator comprising another component with a coating,
wherein the coating of the component and the coating of the another component are different.

7. The sensor of claim 1, wherein the sensing oscillator is less than about one centimeter long.

8. The sensor of claim 1, wherein the environmental sensor measures temperature, pressure, humidity, and/or acceleration.

9. The sensor of claim 1, wherein a footprint of the sensor is less than about six inches by six inches.

10. The sensor of claim 1, wherein a footprint of the sensor is less than about two inches by two inches.

11. The sensor of claim 1, wherein the sensor is positioned on or inside a moving object.

12. The sensor of claim 1, wherein the sensor further comprises:
another component configured to deliver the aerosol particle, liquid-borne analyte, and/or chemical vapor to the outer surface of the another component.

13. A method comprising:
evaluating, using a microcontroller, a frequency of a sensing oscillator having a length of less than about two inches, the evaluating comprising:
using counters to compare time varying frequencies of the sensing oscillator to a control oscillator; and
analyzing frequency data to determine any aerosol particles, liquid-borne analyte, and/or chemical vapors present in an environment.

14. The method of claim 13, further comprising calibrating the frequency data collected from the sensing oscillator using data collected from one or more environmental sensors.

15. The method of claim 13, further comprising sending the frequency data collected from the sensing oscillator to an external processor.

16. The method of claim 13, wherein the analyzing further comprises identifying at least one type of aerosol particle, liquid-borne analyte, and/or chemical vapor.

17. The method of claim 13, further comprising using a piezo-electric quartz crystal for the sensing oscillator.

18. The method of claim 13, wherein the sensing oscillator comprises a length of less than about one centimeter.

19. The method of claim 13, wherein the analyzing is performed by the microcontroller.

20. The method of claim 13, wherein the method is implemented in parallel for at least two of the sensing oscillators.
